(19) United States
(12) Patent Application Publication
(10) Pub. No.: US 2024/0139703 A1
(43) Pub. Date: May 2, 2024

(54) Carbon Dioxide Absorbent, Carbon Dioxide Absorbing Facility, Carbon Dioxide Absorbing Method, and Method for Producing Carbon Dioxide Absorbent

(71) Applicant: Hokkaido Electric Power Company, Incorporated, Hokkaido (JP)

(72) Inventor: Shukichi HASHIDA, Hokkaido (JP)

(21) Appl. No.: 18/557,431

(22) PCT Filed: Mar. 29, 2022
(86) PCT No.: PCT/JP2022/015327

§ 371 Date: Oct. 26, 2023

(30) Foreign Application Priority Data
Apr. 28, 2021 (JP) 2021-075531

(51) Int. Cl. B01J 20/04; B01D 53/04; B01J 20/30

(52) U.S. Cl. CPC B01J 20/041; B01D 53/0446; B01J 20/3078; B01D 2252/10; B01D 2257/504

(57) ABSTRACT

Provided is a carbon dioxide absorbent for absorbing carbon dioxide included in a gas. The carbon dioxide absorbent includes biomass combustion ash that is combustion ash of biomass, the biomass combustion ash including calcium oxide. The biomass may include at least one of wood, a livestock excrement, sewage sludge, or an agricultural residue. The biomass may be excrement evacuated by a chicken for a chicken egg. The carbon dioxide absorbent may be slurry including the biomass combustion ash and water. The carbon dioxide absorbent may be a granule, and may include the biomass combustion ash and a binder.

### TECHNICAL FIELD

The present disclosure relates to a carbon dioxide absorbent, a carbon dioxide absorption facility, a carbon dioxide absorption method, and a method of producing a carbon dioxide absorbent.

### BACKGROUND ART

In recent years, a reduction in carbon dioxide emission from facilities using fossil fuels has been demanded as one of global warming countermeasures. Not only improvement in the thermal efficiency of plants but also pursuit of development of carbon dioxide capture and storage (CCS) technologies is required for reducing the amounts of carbon dioxide emissions from combustion of fossil fuels, and technological development for such purposes has been pursued. For example, Patent Literature 1 discloses a carbon dioxide absorption method in which carbonate ions generated in the desulfurization apparatus of a thermal power plant are bonded to an alkali earth metal or an alkali metal.

### CITATION LIST

### Patent Literature

Patent Literature 1: Unexamined Japanese Patent Application Publication No. 2019-30840

### SUMMARY OF INVENTION

### Technical Problem

In the carbon dioxide absorption method of Patent Literature 1, a large amount of alkali earth metal or alkali metal is used, and it is difficult to obtain large amounts of such substances at low costs. There is also a problem in that the substances have large environmental loads in case of discarding the substances. Such a problem is not limited to the case of absorbing carbon dioxide from exhaust gases generated from the turbines of thermal power plants, but occurs in the case of absorbing carbon dioxide from exhaust gases in other combustion apparatuses.

The present disclosure was based on such a background. An objective of the present disclosure is to provide a carbon dioxide absorbent, a carbon dioxide absorption facility, a carbon dioxide absorption method, and a method of producing a carbon dioxide absorbent that do not impose a load on the environment and can absorb carbon dioxide at low cost.

### Solution to Problem

In order to achieve the objective described above, the carbon dioxide absorbent according to the present disclosure is a carbon dioxide absorbent for absorbing carbon dioxide included in a gas, the carbon dioxide absorbent including biomass combustion ash that is combustion ash of biomass, the biomass combustion ash including calcium oxide.

### Advantageous Effects of Invention

In accordance with the present disclosure, there can be provided a carbon dioxide absorbent, a carbon dioxide absorption facility, a carbon dioxide absorption method, and a method of producing a carbon dioxide absorbent that do not impose a load on the environment and can absorb carbon dioxide at low cost.

### BRIEF DESCRIPTION OF DRAWINGS

FIG. 1 is a schematic view illustrating the configuration of a thermal power plant according to Embodiment 1 of the present disclosure;

FIG. 2 is a view illustrating the configuration of a carbon dioxide absorption facility according to Embodiment 1 of the present disclosure;

FIG. 3 is a view illustrating the configuration of a carbon dioxide absorption facility according to Embodiment 2 of the present disclosure;

FIG. 4 is a schematic view illustrating the configuration of a thermal power plant according to a modified embodiment of the present disclosure;

FIG. 5 is a view illustrating the results of fluorescent X-ray measurement of ashes that are generated by incinerating chicken excrement, and to which water is added, in Example; and

FIG. 6 is a graph illustrating the results of X-ray diffraction measurement of the ashes that are generated by incinerating the chicken excrement, and to which water is added, in Example.

### DESCRIPTION OF EMBODIMENTS

A carbon dioxide absorbent, a carbon dioxide absorption facility, a carbon dioxide absorption method, and a method of producing a carbon dioxide absorbent according to embodiments of the present disclosure are described in detail below with reference to the drawings. In each drawing, the same or similar portions are denoted by the same reference characters.

### Embodiment 1

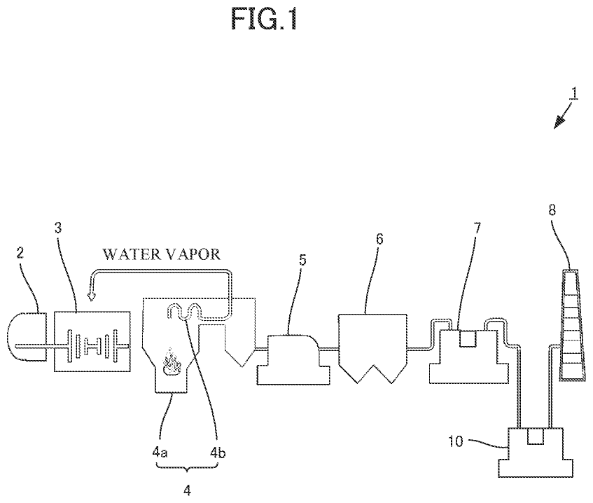

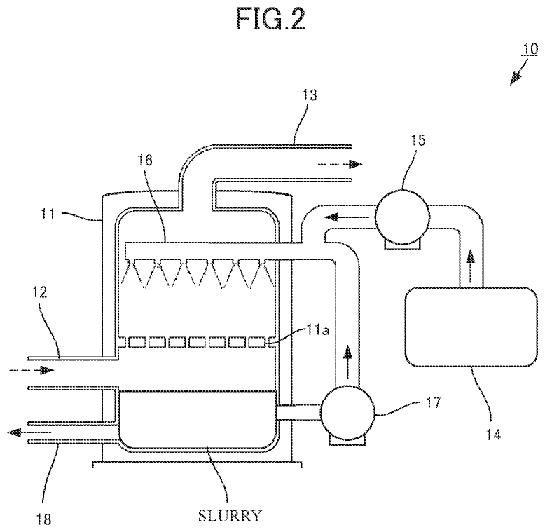

The carbon dioxide absorbent, the carbon dioxide absorption facility, the carbon dioxide absorption method, and the method of producing a carbon dioxide absorbent according to Embodiment 1 are described with reference to FIGS. 1 and 2. The carbon dioxide absorbent absorbs carbon dioxide included in a gas by chemical reaction with the carbon dioxide. For example, the carbon dioxide absorbent is accommodated in the carbon dioxide absorption facility, absorbs carbon dioxide in a gas taken in the carbon dioxide absorption facility, and changes the gas into a treated gas obtained by removing the carbon dioxide. The carbon dioxide absorption facility is installed in an exhaust system that emits an exhaust gas from a fossil fuel, the exhaust gas being generated in, for example, a thermal power plant or an ironworks, and changes the exhaust gas into a treated gas.

The carbon dioxide absorbent according to Embodiment 1 is generated by water and combustion ash (biomass combustion ash) obtained by burning biomass. The biomass combustion ash includes calcium oxide CaO, and calcium hydroxide Ca(OH)₂ is generated by adding water to calcium oxide. When calcium hydroxide comes into contact with carbon dioxide CO₂, both cause chemical reaction to generate calcium carbonate CaCO₃. Carbon dioxide (carbonate ions) in exhaust gas can be absorbed by the chemical reaction.

The amount of calcium oxide included in the carbon dioxide absorbent depends on the kind of the biomass may be set at an appropriate value in consideration of economical efficiency and the reaction efficiency of absorption of carbon dioxide. Calcium carbonate generated after the absorption of carbon dioxide by the carbon dioxide absorbent may be effectively utilized in an application similar to that of other industrially generated calcium carbonate.

The biomass is preferably biomass including a large amount of a calcium compound that is changed into calcium oxide by combustion of the biomass. The combustion temperature of the biomass is such a temperature that a calcium compound is changed into calcium oxide, for example, in a range of 800° C. to 1500° C., and more preferably around 1000° C. Examples of the biomass include wood, livestock excrements, sewage sludge, and agricultural residues.

Especially, the livestock excrements, particularly excrements from chickens for chicken eggs, include a large amount of a calcium compound that is changed into calcium oxide at a combustion temperature of around 1000° C., and are preferred as raw materials for the carbon dioxide absorbent. This is because livestock, particularly chickens for chicken eggs, are fed with livestock food including a large amount of calcium, and the livestock excrements, particularly the excrements from the chickens for chicken eggs, include calcium compounds incapable of being sufficiently digested in the bodies of the livestock, and calcium compounds excreted after the digestion.

Char (charcoal-like unburned matter) obtained by combustion of wood in a gasification furnace also includes calcium oxide at a weight ratio of around 50%, and is therefore preferred as a raw material for the carbon dioxide absorbent. On the other hand, the bones of livestock include large amounts of calcium phosphate and apatite, and the calcium compounds thereof are not preferred as raw materials for the carbon dioxide absorbent because the calcium compounds are not changed into calcium oxide even at a combustion temperature of 1000° C. or more.

The carbon dioxide absorbent according to Embodiment 1 is slurry (wet absorbent) formed of biomass combustion ash and water. The slurry is produced by mixing the biomass combustion ash with the water and stirring the mixture by a mixer, and includes calcium hydroxide generated by reaction between calcium oxide and water. The weight ratio between the biomass combustion ash and the water in the slurry is, for example, 1:1.

The amount of the water added to the biomass combustion ash is an amount necessary for changing the calcium oxide of the biomass combustion ash into calcium hydroxide. For example, the theoretical value of the amount of water necessary for changing calcium oxide in 1 kilogram of biomass combustion ash into calcium hydroxide is up to about 1.6 L at a temperature of 20° C. when being calculated from the solubility of calcium oxide. In an actual step of generating slurry, however, water of which the amount is smaller than the theoretical value may be added to biomass combustion ash because the water is added to allow continuous reaction of calcium oxide at a temperature of several tens of degrees Celsius.

Calcium hydroxide is industrially generated by pulverizing limestone, burning the limestone with fossil fuel to generate calcium oxide, and adding water to the calcium oxide, whereas biomass combustion ash including calcium hydroxide is generated by burning in a biomass thermal power plant or a biomass incineration facility. The combustion of the biomass is not counted as carbon dioxide emission because fossil fuel is not used in the combustion. Thus, the combustion is carbon-neutral. Moreover, biomass combustion ash is generated with naturally-derived biomass as a raw material, does not include any substance such as an alkali earth metal or an alkali metal, and therefore has a low environmental load.

In addition, biomass combustion ash obtained from a biomass combustion facility such as a biomass thermal power plant or a boiler for biomass heat supply has the following advantages. First, the biomass combustion ash can be obtained at low cost because the biomass combustion ash is a by-product generated by electricity generation or heat supply. Moreover, the biomass combustion facility is a carbon-neutral power source that does not use fossil fuel, and can be expected to come into future widespread use, and therefore, stable supply of biomass incinerated ash can be expected. Use of a carbon dioxide absorbent generated from combustion ash from the biomass combustion facility in absorption of carbon dioxide in a thermal power plant, a boiler for heat supply, or an industrial facility using fossil fuel, such as a facility for manufacturing iron, enables a reduction in carbon dioxide emission in industry as a whole.

Then, the configuration of a carbon dioxide absorption facility 10 according to Embodiment 1 is described. The case of absorbing oxygen dioxide in exhaust gas emitted from a thermal power plant is described as an example below.

As illustrated in FIG. 1, the carbon dioxide absorption facility 10 is connected to the exhaust system of a thermal power plant 1, and removes carbon dioxide from exhaust gas generated in a boiler 4. The thermal power plant 1 further includes a power generator 2 that generates electricity, a turbine 3 that rotates the power generator 2, the boiler 4 that supplies water vapor to the turbine 3, a denitration apparatus 5 that removes a nitrogen oxide from exhaust gas generated in the boiler 4, an electrostatic precipitator 6 that removes powder dust from exhaust gas generated in the boiler 4, a desulfurization apparatus 7 that removes a sulfur oxide from exhaust gas generated in the boiler 4, and a chimney 8 that releases, to atmosphere, exhaust gas generated in the boiler 4, as well as the carbon dioxide absorption facility 10. The boiler 4 is an example of a combustion apparatus that allows combustion of fuel, and includes a combustion chamber 4a in which combustion of fuel is performed, and a heat exchanger 4b that is placed in the interior of the combustion chamber 4a, and generates water vapor by combustion of fuel.

The rotation shaft of turbine 3 is mechanically connected to the rotation shaft of the power generator 2, and the heat exchanger 4b of the boiler 4 is connected to the turbine 3 via a pipe through which water vapor can flow. The combustion chamber 4a of the boiler 4, the denitration apparatus 5, the electrostatic precipitator 6, the desulfurization apparatus 7, the carbon dioxide absorption facility 10, and the chimney 8 are serially connected via pipes through which exhaust gas can flow.

The carbon dioxide absorption facility 10 internally accommodates the carbon dioxide absorbent, allows the carbon dioxide absorbent to absorb carbon dioxide in exhaust gas supplied from the outside, and then emits the carbon dioxide to the outside. The carbon dioxide absorption facility 10 includes, for example, the same or similar configuration as or to that of the desulfurization apparatus 7. The desulfurization apparatus 7 is classified into a wet-type desulfurization apparatus using slurry including calcium carbonate in absorption of sulfurization oxide and a dry-type desulfurization apparatus using a granule including calcium carbonate. A cost required for installation and maintenance of the carbon dioxide absorption facility 10 can be reduced by allowing the carbon dioxide absorption facility 10 to include the same or similar configuration as or to that of the desulfurization apparatus 7 that has been already placed in the thermal power plant. In Embodiment 1, a case in which the carbon dioxide absorbent is slurry and a wet-type carbon dioxide absorption facility is adopted as the carbon dioxide absorption facility 10 is described as an example.

The carbon dioxide absorption facility 10 absorbs carbon dioxide included in exhaust gas by spraying the slurry (carbon dioxide absorbent) of biomass combustion ash including calcium hydroxide on exhaust gas taken in the interior of a tank.

As illustrated in FIG. 2, the carbon dioxide absorption facility 10 includes: an absorption tower 11 that receives slurry; a gas supply pipe line 12 through which exhaust gas is supplied to the absorption tower 11; a gas exhaust pipe line 13 through which a treated gas obtained by removing carbon dioxide is emitted from the absorption tower 11; a slurry storage tank 14 in which slurry is stored; a slurry supply pump 15 by which the slurry is supplied from the slurry storage tank 14 to the absorption tower 11; a spray pipe 16 through which the slurry is released into the absorption tower 11; a circulation pump 17 by which the slurry released into the absorption tower 11 is collected and recirculated into the absorption tower 11; and a slurry exhaust pipe line 18 through which the slurry is exhausted outside the absorption tower 11. The absorption tower 11 is an example of a tank that accommodates the carbon dioxide absorbent, and includes a backflow prevention plate 11a that prevents slurry downward released from the spray pipe 16 from flowing backward. A large number of holes through which exhaust gas can pass are opened in the backflow prevention plate 11a.

In FIG. 2, each solid arrow indicates the flow of the slurry, and each dashed arrow indicates the flow of the gas. In the carbon dioxide absorption facility 10, slurry as the carbon dioxide absorbent is sprayed, from the spray pipe 16, on exhaust gas taken from the boiler 4 into the absorption tower 11. In operation of the thermal power plant, the slurry is always released from the spray pipe 16 into the absorption tower 11, part of the reacted slurry is circulated to return into the absorption tower 11 again by the circulation pump 17, and the remainder thereof is always exhausted outside the absorption tower 11 from the slurry exhaust pipe line 18.

The configuration of the carbon dioxide absorption facility 10 is described above.

Then, the flow of a carbon dioxide absorption method executed using the carbon dioxide absorption facility 10 according to Embodiment 1 is described.

First, the carbon dioxide absorbent is supplied into the interior of the absorption tower 11 (supply step). Specifically, the slurry supply pump 15 is activated, and the slurry is released from the spray pipe 16 into the absorption tower 11.

Then, exhaust gas including carbon dioxide is brought into contact with the carbon dioxide absorbent supplied into the interior of the absorption tower 11 (contact step). The supply of the exhaust gas from the gas supply pipe line 12 into the absorption tower 11 allows the slurry released from the spray pipe 16 and the exhaust gas supplied from the gas supply pipe line 12 to come into contact with each other, to result in reaction of calcium hydroxide included in the slurry with carbon dioxide, whereby the calcium hydroxide is changed into calcium carbonate.

Then, the carbon dioxide absorbent that has come into contact with the exhaust gas including carbon dioxide, that is, the carbon dioxide absorbent including calcium carbonate is removed from the absorption tower 11 (removal step). Specifically, part of the reacted slurry including calcium carbonate is exhausted outside from the absorption tower 11 through the slurry exhaust pipe line 18, and the remaining slurry is released from the spray pipe 16 into the interior of the absorption tower 11 through the circulation pump 17. Each step is executed in parallel in the carbon dioxide absorption facility 10.

The flow of the carbon dioxide absorption method executed using the carbon dioxide absorption facility 10 is described above.

As described above, the carbon dioxide absorbent according to Embodiment 1 is a carbon dioxide absorbent for absorbing carbon dioxide included in gas, and includes biomass combustion ash that is the combustion ash of biomass, and the biomass combustion ash includes calcium oxide. Therefore, the carbon dioxide absorbent does not impose a large load on the environment and can absorb carbon dioxide in exhaust gas at low cost.

The carbon dioxide absorbent according to Embodiment 1 is slurry including biomass combustion ash and water. Therefore, absorption of carbon dioxide in exhaust gas can be achieved using the wet-type carbon dioxide absorption facility 10 including the same or similar configuration as or to that of the wet-type desulfurization apparatus 7.

### Embodiment 2

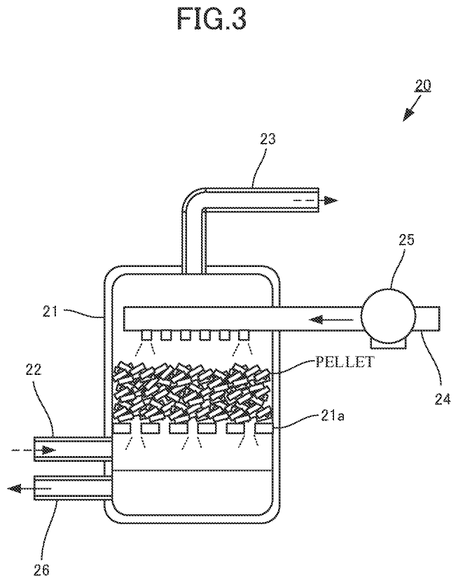

A carbon dioxide absorbent, a carbon dioxide absorption facility, a carbon dioxide absorption method, and a method of producing a carbon dioxide absorbent according to Embodiment 2 are described with reference to FIG. 3. The carbon dioxide absorbent according to Embodiment 1 is slurry, while the carbon dioxide absorbent according to Embodiment 2 is a granule (dry absorbent). Explanations are provided below with an emphasis on differences between both.

The carbon dioxide absorbent according to Embodiment 2 is a granule including biomass combustion ash as a main component. The granule of the carbon dioxide absorbent is generated by adding a binder and, as needed, water to biomass combustion ash, mixing the resultant, and molding the mixture. The binder plays a role in aggregating the particles of the biomass combustion ash. The granule may be subjected to steam curing to express strength at an early stage.

The granule is, for example, a pellet. The pellet is a granule compressed and molded to have a cylindrical shape by piston granulation (pellet granulation) or press molding. In the piston granulation, the granule having a cylindrical shape is molded by, for example, adding a binder and water to biomass combustion ash, kneading the resultant by a kneading machine, then passing the kneaded material through a large number of holes opened in a plate, and cutting such a material to have a certain length by a cutter.

The amount of water, required for molding the pellet, is, for example, in a range of 0% to 40% by weight ratio in consideration of the easiness of the molding and the strength of the pellet. The amount of water is preferably in a range of 0% to 15% in the press molding, and preferably in a range of 30% to 40% in the piston granulation. It is not necessary to change total calcium oxide into calcium hydroxide in the molding of the granule because water can be brought into contact with the granule to change the calcium oxide of the granule into calcium hydroxide when carbon dioxide is absorbed in the carbon dioxide absorbent that is the granule.

The binder includes plaster, cement, soda ash, clay, or an organic polymer such as alginic acid or polyvinyl alcohol. The binder is preferably a binder including calcium sulfate, and preferably plaster. Desulfurized plaster generated by a thy-type or wet-type desulfurization process is preferably used as the plaster.

Then, the configuration of a carbon dioxide absorption facility 20 according to Embodiment 2 is described. The carbon dioxide absorption facility 20 is a dry-type carbon dioxide absorption facility in which exhaust gas taken therein is brought into contact with a granule that is a carbon dioxide absorbent to absorb carbon dioxide included in the exhaust gas. Like the carbon dioxide absorption facility 10, the carbon dioxide absorption facility 20 is connected to the exhaust system of the thermal power plant 1, and may be connected, for example, between the desulfurization apparatus 7 and the chimney 8 through a pipe line.

As illustrated in FIG. 3, the carbon dioxide absorption facility 20 includes: an absorption tower 21 into which granules (for example, pellets) are filled; a gas supply pipe line 22 through which exhaust gas is supplied into the interior of the absorption tower 21; a gas exhaust pipe line 23 through which a treated gas obtained by removing carbon dioxide is emitted from the absorption tower 21 to the outside; a water supply pipe line 24 through which water is supplied into the interior of the absorption tower 21; a pump 25 that is placed in the water supply pipe line 24 and sends water in the water supply pipe line 24; and a water exhaust pipe line 26 through which water is exhausted from the absorption tower 21 to the outside. Each of the gas supply pipe line 22, the gas exhaust pipe line 23, the water supply pipe line 24, and the water exhaust pipe line 26 is connected to the absorption tower 21.

The absorption tower 21 is an example of a tank that accommodates a carbon dioxide absorbent. A drop prevention plate 21a that prevents a granule from dropping downward is disposed in the absorption tower 21. A large number of such holes that granules are incapable of passing through the holes are opened in the drop prevention plate 21a. An openable and closable input port (not illustrated) into which a granule is put is disposed in the upper portion of the absorption tower 21, and an exhaust port (not illustrated) from which a granule can be exhausted is disposed in the lower portion of the absorption tower 21.

The gas supply pipe line 22 is connected to an area closer to a bottom surface than the drop prevention plate 21a of the absorption tower 21, and the gas exhaust pipe line 23 is connected to an area closer to the upper surface of the absorption tower 21. The water supply pipe line 24 is connected to an area closer to the upper surface of the absorption tower 21, and the water exhaust pipe line 26 is connected to an area closer to the bottom surface than the gas supply pipe line 22 and the drop prevention plate 21a of the absorption tower 21.

In FIG. 3, each solid arrow indicates the flow of water, and each dashed arrow indicates the flow of gas. Water supplied from the water supply pipe line 24 drops, in spray form, toward granules filled in the absorption tower 21 comes into contact with the granules, to change calcium oxide in the granules into calcium hydroxide, and is then exhausted from the water exhaust pipe line 26 in a lower area. Moreover, exhaust gas introduced from the gas supply pipe line 22 into the absorption tower 21 flows from the lower area to upper area of the absorption tower 21, and passes between the granules in such a case, whereby the exhaust gas is changed into a treated gas obtained by removing carbon dioxide, and exhausted from the gas exhaust pipe line 23 toward the outside. Granules reacted with carbon dioxide may be regularly taken from the exhaust port (not illustrated) in the lower area of the absorption tower 21, and new granules may be put from the input port in the upper area of the absorption tower 21.

The configuration of the carbon dioxide absorption facility 20 is described above.

As described above, the carbon dioxide absorbent according to Embodiment 2 is a granule, and includes biomass combustion ash and a binder. Therefore, absorption of carbon dioxide in exhaust gas can be achieved using the same or similar dry-type carbon dioxide absorption facility 20 as or to the dry-type desulfurization apparatus 7.

The present disclosure is not limited to the embodiments described above, and a modified embodiment described below is also possible.

### Modified Embodiment

In the embodiments described above, the carbon dioxide absorption facility 10, 20 is installed between the desulfurization apparatus 7 and the chimney 8. However, the present disclosure is not limited thereto. The carbon dioxide absorption facility 10, 20 may be placed at any position as long as the carbon dioxide absorption facility is the exhaust system of a thermal power plant. For example, the carbon dioxide absorption facility 10, 20 may be placed between the electrostatic precipitator 6 and the desulfurization apparatus 7.

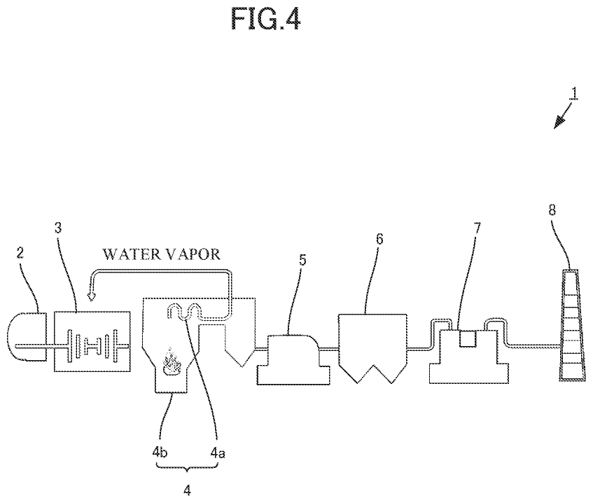

In the embodiments described above, the carbon dioxide absorption facility 10, 20 different from the desulfurization apparatus 7 is installed. However, the present disclosure is not limited thereto. For example, the desulfurization apparatus 7 that has been already placed may also be used as a carbon dioxide absorption facility in such a thermal power plant as illustrated in FIG. 4, or the desulfurization apparatus 7 that has been already placed may be remodeled and also be used as a carbon dioxide absorption facility.

For example, when the desulfurization apparatus 7 is a wet-type desulfurization apparatus, slurry of calcium carbonate for desulfurization may be mixed with biomass combustion ash for absorption of carbon dioxide, and the slurry may be sprayed on exhaust gas in the tank of the desulfurization apparatus 7. When the desulfurization apparatus 7 is a thy-type desulfurization apparatus, pellets produced from biomass combustion ash as well as pellets of calcium carbonate for desulfurization may be filled into the absorption tower of the desulfurization apparatus 7 that has been already placed. In such a method, a cost resulting from absorption of carbon dioxide can be further reduced because it is not necessary to further build a new facility in the thermal power plant 1.

In Embodiment 2 as described above, the pellet is produced as a granule. However, the present disclosure is not limited thereto. The granule may be produced using, for example, a granulation method other than a piston granulation method, for example, a tumbling granulation method or an agitation granulation method.

In the embodiments described above, the carbon dioxide absorption method starts from the step of releasing the slurry including biomass incinerated ash into the absorption tower 11. However, the present disclosure is not limited thereto. For example, the carbon dioxide absorption method may include a step of generating a carbon dioxide absorbent from biomass combustion ash exhausted in a biomass thermal power plant that performs combustion of biomass to generate electricity (generation step). The carbon dioxide absorption method may also include a step of performing combustion of biomass in the biomass thermal power plant to generate electricity (electricity generation step) prior to the generation step. In biomass thermal power generation, the total or part of fuel includes biomass, and combustion of the fuel including biomass is performed based on the same principle as that of thermal power generation using fossil fuel, to generate electricity.

In the embodiments described above, calcium carbonate generated after the absorption of carbon dioxide by the carbon dioxide absorbent is effectively utilized in an application similar to that of industrially produced calcium carbonate. However, the present disclosure is not limited thereto. For example, calcium carbonate generated after absorption of carbon dioxide may be mixed with fly ash and calcium sulfate to generate an algal reef, the algal reef may be placed underwater, and seaweed or sea grass may be allowed to adhere to the algal reef to achieve fixation of carbon dioxide by the seaweed or the sea grass.

In the embodiments described above, the carbon dioxide absorption facility is applied to the thermal power plant. However, the present disclosure is not limited thereto. The carbon dioxide absorption facility may be applied to other facilities that emit carbon dioxide, for example, ironworks, refineries, and garbage and sewage plants.

The embodiments described above are examples, the present disclosure is not limited thereto, and various embodiments are possible without departing from the gist of the invention described in claims. The components described in each embodiment and the modified embodiment can be freely combined. An invention equivalent to the invention described in claims is also included in the present disclosure.

The present disclosure is specifically described below with reference to Examples. However, the present disclosure is not limited to these Examples.

### Examples

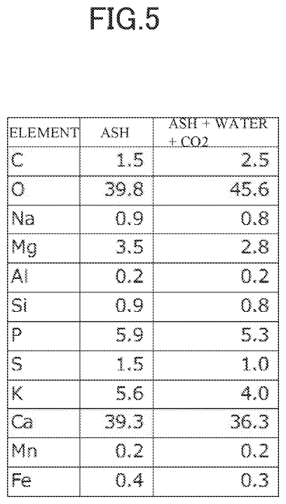

Tests to demonstrate whether biomass combustion ash absorbs carbon dioxide were conducted in Examples. The biomass combustion ash is chicken excrement ash generated by burning chicken excrement at 1100° C. for 1 hour. The ash content of the chicken excrement ash was about 20% on the basis of calculation from an ignition loss. Moreover, 55% (weight ratio) of the chicken excrement ash was calcium oxide. Water of which the weight was equal to that of the biomass combustion ash was added to the biomass combustion ash, and the resultant was sufficiently stirred to generate slurry. Carbon dioxide was passed through the slurry using an experimental device, and the chemical compositions of the slurry before and after the passage of carbon dioxide were analyzed using an X-ray fluorescence spectrometer and an X-ray diffractometer. The results of the fluorescent X-ray measurement are described below. As illustrated in FIG. 5, the elemental weight percents of carbon and oxygen in the slurry before the passage of carbon dioxide were 1.5% and 39.8%, respectively, while the elemental weight percents of carbon and oxygen in the slurry after the passage of carbon dioxide were increased to 2.5% and 45.6%, respectively. This is considered to be because calcium hydroxide in the slurry reacted with carbon dioxide to generate calcium carbonate including carbon and oxygen atoms.

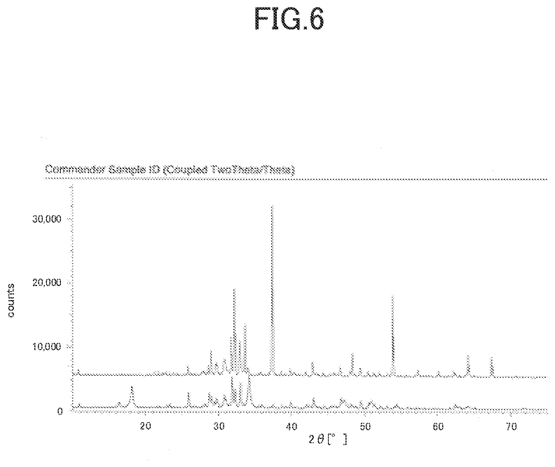

Then, the results of the line X-ray measurement are described. The waveform in the upper area of FIG. 6 indicates the measurement data of the chicken excrement ash, while the waveform in the lower area thereof indicates the measurement data of the chicken excrement ash to which water was added and through which carbon dioxide was passed. As illustrated in FIG. 6, the peaks of calcium oxide and apatite were present before the passage of carbon dioxide, while the peak of calcium carbonate occurred after the passage of carbon dioxide. This means that calcium carbonate was formed as a result of absorption of carbon dioxide by calcium oxide in the combustion ash. Thus, the absorption of carbon dioxide by the biomass combustion ash was able to be confirmed.

This application claims the benefit of Japanese Patent Application No. 2021-75531, filed on Apr. 28, 2021, the entire disclosure of which is incorporated by reference herein.

### INDUSTRIAL APPLICABILITY

The carbon dioxide absorbent, the carbon dioxide absorption facility, the carbon dioxide absorption method, and the method of producing a carbon dioxide absorbent of the present disclosure do not impose a load on the environment, can absorb carbon dioxide at low cost, and are therefore useful.

### REFERENCE SIGNS LIST

1 Thermal power plant
10, 20 Carbon dioxide absorption facility
11, 21 Absorption tower
12, 22 Gas supply pipe line
13, 23 Gas exhaust pipe line

1. A carbon dioxide absorbent for absorbing carbon dioxide included in a gas, the carbon dioxide absorbent comprising:
biomass combustion ash that is combustion ash of biomass, the biomass combustion ash including calcium oxide.

2. The carbon dioxide absorbent according to claim 1,
wherein the biomass includes at least one of wood, a livestock excrement, sewage sludge, or an agricultural residue.

3. The carbon dioxide absorbent according to claim 1, wherein the biomass is excrement evacuated by a chicken for a chicken egg.

4. The carbon dioxide absorbent according to claim 1, wherein the carbon dioxide absorbent is slurry including the biomass combustion ash and water.

5. The carbon dioxide absorbent according to claim 1, wherein the carbon dioxide absorbent is a granule and includes the biomass combustion ash and a binder.

6. A carbon dioxide absorption facility that is connected to an exhaust system of a combustion apparatus, the carbon dioxide absorption facility comprising:
a tank that internally accommodates the carbon dioxide absorbent according to claim 1;
a gas supply pipe line that is connected to the tank and through which exhaust gas from the combustion apparatus is supplied into an interior of the tank; and
a gas exhaust pipe line that is connected to the tank and through which a treated gas obtained by removing carbon dioxide in the exhaust gas by the carbon dioxide absorbent is emitted outside the tank.

7. A carbon dioxide absorption method comprising:
supplying the carbon dioxide absorbent according to claim 1 into an interior of a tank;
bringing exhaust gas including carbon dioxide into contact with the carbon dioxide absorbent supplied into the interior of the tank; and
removing, from the tank, the carbon dioxide absorbent that comes into contact with the exhaust gas.

8. The carbon dioxide absorption method according to claim 7, further comprising:
performing combustion of biomass to generate electricity in a biomass thermal power plant; and
generating the carbon dioxide absorbent from biomass combustion ash exhausted in the biomass thermal power plant, wherein
in the supplying, the carbon dioxide absorbent generated in the generating is supplied into the interior of the tank.

9. A method of producing a carbon dioxide absorbent, the method comprising:
performing combustion of biomass; and
generating slurry or a granule from biomass combustion ash that is exhausted by the combustion of the biomass and includes calcium oxide.
